(19) United States
(12) Patent Application Publication
(10) Pub. No.: US 2022/0382590 A1
(43) Pub. Date: Dec. 1, 2022

(54) CLOUD PROVIDER ACCOUNT MAPPINGS

(71) Applicant: HashiCorp, San Francisco, CA (US)

(72) Inventors: Mitchell Hashimoto, Los Angeles, CA (US); Paul Seiffert, Augsburg (DE); Alex Dadgar, Seattle, WA (US); Tobias Meyer, Timmendorfer Strand (DE)

(21) Appl. No.: 17/334,449

(22) Filed: May 28, 2021

(51) Int. Cl. G06F 9/50

(52) U.S. Cl. CPC G06F 9/5022; G06F 9/5072

(57) ABSTRACT

Techniques are described for providing a method of creating and managing mappings between cloud based resources and cloud provider accounts. Specifically, the present disclosure presents a method executed by a centralized service for acquiring account credentials associated with a cloud provider account from a cloud provider. The centralized service is further configured to receive a request to allocate account credentials to a network resources. After receiving the request, the centralized service generates a mapping of the cloud provider account with the network resource based at least in part on the acquired account credentials of the cloud provider account. Finally, the centralized service returns the mapping based on the cloud provider account.

### TECHNICAL FIELD

This disclosure generally relates to techniques for managing cloud based resources and cloud provider accounts. Specifically, the present disclosure proposes a mechanism for mapping cloud based resources to cloud accounts of cloud service providers.

### BACKGROUND

Generally, cloud providers offer many services such as online applications, computing power, data storage, infrastructure, and software. These services can be grouped into one of: infrastructure as a service (IaaS), platform as a service (PaaS), and software as a service (SaaS). Typically, IaaS are online services that provide high-level application programming interfaces (APIs) used to dereference various low-level details of underlying network infrastructure like physical computing resources, location, data partitioning, scaling, security, backup etc. These services are provided by a number of commercial entities such as Amazon Web Services, Google Cloud Platform, and Microsoft Azure.

In the context of IaaS, many cloud providers offer users the ability to create a virtual private cloud in which they can provision computing resources. A virtual private cloud (VPC) is an on-demand configurable pool of shared resources allocated within a public cloud environment, providing a certain level of isolation between the different users utilizing the resources. The isolation between one VPC user and all other users of the same cloud (i.e. other VPC users as well as other public cloud users) is achieved normally through allocation of a private IP subnet and a virtual communication construct such as a virtual local area network (VLAN) or a set of encrypted communication channels per user. With the introduction of these isolation levels, a user using this service is in effect working on a ‘virtually private’ cloud. Once a user has created a VPC, they can provision a number of other resources within the VPC, such as virtual machines (VMs) and block level storage, in order to host their applications and data.

In cloud computing, the control of the backend infrastructure is limited to the cloud vendor only. Cloud providers often decide on the management policies, which moderates what the cloud users are able to do with their accounts and deployment. Cloud users are also limited to the control and management of their applications, data, and services. This includes limits on the number of VPCs per account.

In addition, many features of a cloud provider are restricted to the same account. For example, a VM can most easily be attached to a network in the same account. Thus, users who require resources in excess of the account limits imposed by the cloud providers may face connectivity issues as they continue to add resources. For example, a user who intends on creating more resources than the limit per account may create multiple accounts. However, due to the restrictions between accounts, the user must be careful to provision new resources in the same account as the other existing resources to which the new resource needs access. As the number of accounts and resources grows, keeping an accurate mapping of accounts to resources may become unwieldy and extremely burdensome. In addition, this creates a challenge when attempting to automate the process of resource creation.

Accordingly, there is a need for a mechanism to create and manage mappings between cloud resources and cloud accounts. Specifically, there is a need for a centralized service to be able to acquire account information from cloud providers, allocate resources to an account, and store information pertaining to the allocation for future reference when creating additional resources. The embodiments discussed herein below represent numerous improvements to the fields of computing, cloud computing, Software as a Service, Infrastructure as a Service, and computer automation. In addition, many embodiments improve the user experience and increase accuracy and consistency in the field of automated network and software architecture design and creation.

### SUMMARY

The present disclosure describes techniques for providing mappings between cloud accounts and network resources. Various embodiments are described herein, including methods, systems, non-transitory computer-readable storage media storing programs, code, or instructions executable by one or more processors, and the like. Embodiments of the invention add a new concept to managing the creation of network resources within cloud accounts provided by various cloud service providers while maintaining connectivity between the resources. The present disclosure provides a method for creating and managing mappings between cloud based resources and cloud provider accounts using a centralized service.

In certain embodiments, a centralized service acquires account credentials associated with a cloud provider account from a cloud provider. The centralized service then receives a request to allocate account credentials to a network resource. After receiving the request, the centralized service generates a mapping between the cloud provider account and the network resource based at least in part on the acquired account credentials of the cloud provider account. After generating the mapping, the centralized service returns the mapping to the source of the request.

In an example embodiment, the centralized service stores the mapping of the cloud provider account with the network resource in a data store.

In the above embodiment, in response to the request to allocate account credentials to the network resource, the centralized service identifies an existing mapping of the network resource with the cloud provider account in the data store and returns the existing mapping to the source of the request.

In an example embodiment, the centralized service erases the mapping upon destruction of the corresponding network resource.

In certain embodiments, the centralized service acquires account credentials associated with a second cloud provider account of the cloud provider. The centralized service then receives a request to allocate the account credentials of the second cloud provider account to a second network resource. After receiving the request, the centralized service generates a mapping of the second cloud provider account with the second network resource based at least in part on the acquired account credentials of the second cloud provider account. After generating the mapping, the centralized service returns the mapping to the source of the request.

In an example embodiment, the centralized service comprises a remote procedure call (RPC) service.

In another embodiment, the network resource includes a virtual network.

In certain embodiments, the network resource includes a virtual private cloud (VPC).

In an example embodiment, the centralized service receives a second request to allocate a cloud provider account to the network resource. After receiving the second request, the centralized service identifies the existing mapping of the network resource with the cloud provider account in a data store and returns the existing mapping to the source of the second request.

In certain embodiments, the request to allocate one of the one or more cloud provider accounts to the network resource further comprises an account identifier for a specific account to be allocated to the network resource.

In another embodiment, the request to allocate a cloud provider account to the network resource further comprises a request to allocate the network resource to a specific cloud provider.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a high-level system overview of provider service in connection with cloud service providers and a resource manager.

FIG. 2 depicts an example of the logical structure within a cloud service provider

FIG. 3 depicts an example of steps performed to map cloud provider accounts with network resources.

FIG. 4 depicts an example of steps performed to map cloud provider accounts from multiple cloud providers with network resources.

FIG. 5 depicts an example of steps performed to manage mappings of cloud provider accounts and network resources.

FIG. 6 depicts a flow diagram of an example method for managing cloud provider account mappings.

FIG. 7 depicts a flow diagram of an example method for mapping cloud provider accounts with network resources.

FIG. 8 depicts a flow diagram of an example method for erasing mappings of cloud provider accounts with network resources.

### DETAILED DESCRIPTION

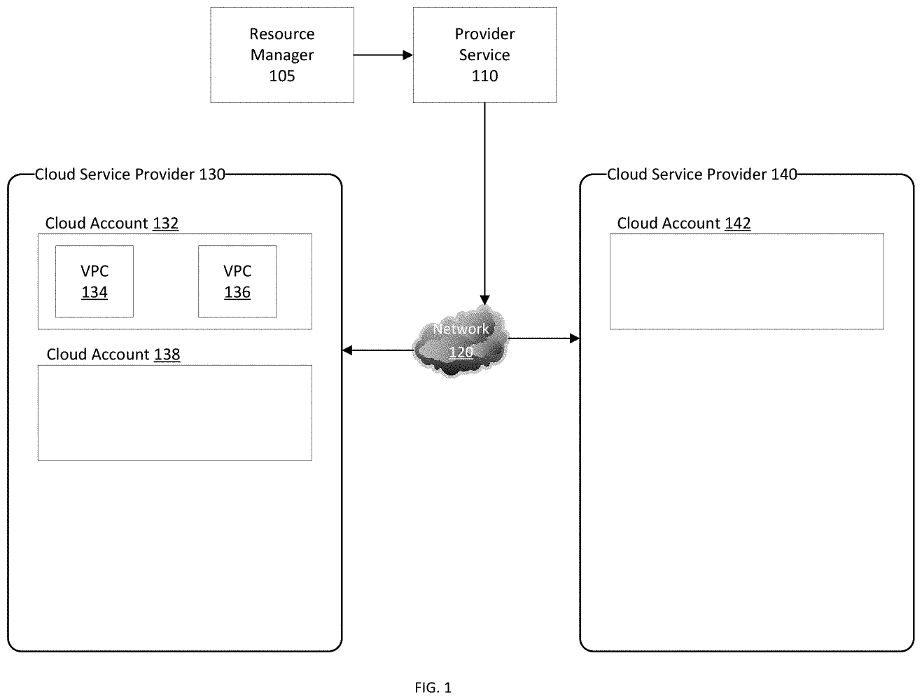

FIG. 1 depicts an example of a high-level system overview of provider service 110 in connection with cloud service providers 130, 140 and a resource manager 105. In an example embodiment, a provider service 110 may connect over a network 120 to one or more cloud service providers 130, 140. The cloud service providers 130, 140 may be any of a number of commercially available cloud service providers. For example, cloud service provider 130 may be a service provided by Amazon, while cloud service provider 140 is a service provided by Microsoft or Google.

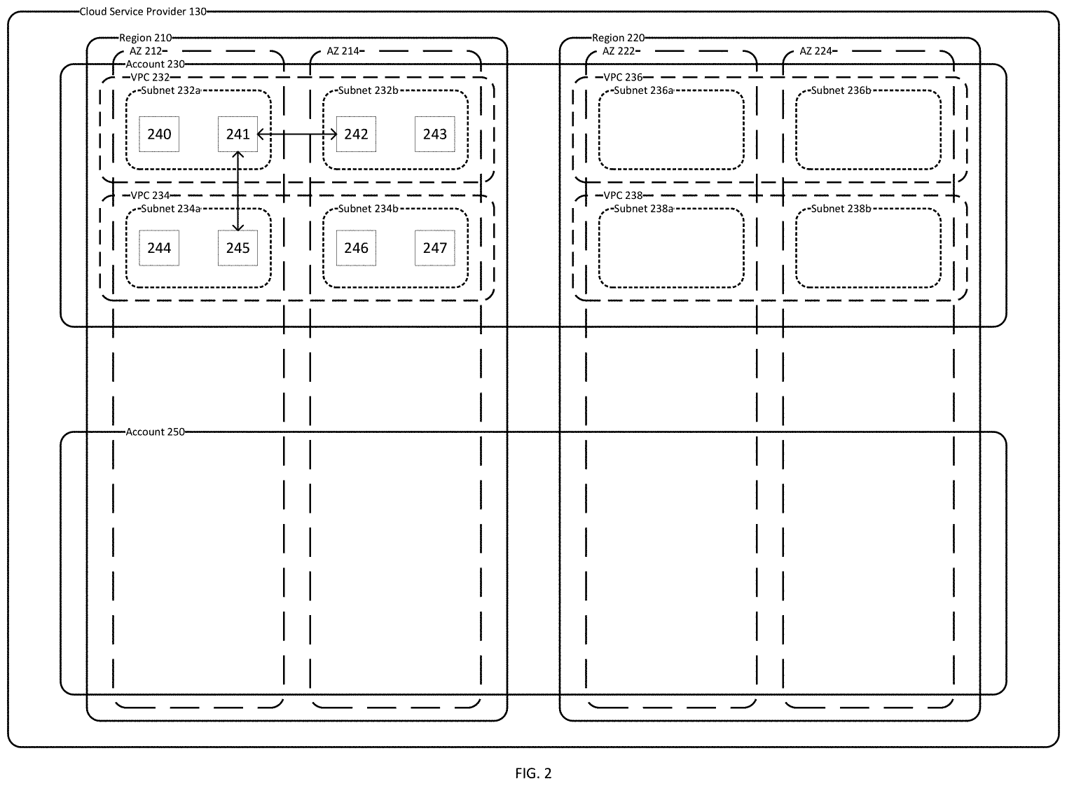

In many embodiments, the cloud service providers 130, 140 may offer the ability to create network resources with the infrastructure provided by the cloud service providers 130, 140. For example, the network resources may be Virtual Private Clouds (VPCs) 134, 136. While not shown in FIG. 1, additional resources may also include virtual private networks (VPNs), network accessible storage, virtual machines, or any other resource offered by a commercial cloud service provider. In some embodiments, the cloud service providers 130, 140 may use cloud accounts 132, 138, 142 in order to manage and organize the various resources available to consumers. While there are additional logical structures implemented to manage and organize resources by a cloud service provider, they will be further discussed herein below with reference to FIG. 2

In various embodiments, cloud service providers 130, 140 may restrict cloud accounts 132, 138, 142 to a certain number of resources or services. For example, cloud service provider 130 may restrict each cloud account 132, 138 to only two VPCs per account. In this instance, because cloud account 132 has two VPCs 134, 136, a user wanting to create additional VPCs using cloud service provider 130 services must create them in a separate cloud account 138. It should be understood that a limit of two VPCs per account is used for example only and the limits may be much higher. Likewise, while a limit on the number of resources is discussed herein, cloud accounts 134, 136, 138 may have other restrictions such as network access between cloud accounts, as further discussed in reference to FIG. 2. Similarly, cloud service provider 130 may have different restrictions as compared with cloud service provider 140. For example, cloud service provider 140 may organize and restrict network resources based on subscriptions or tenants.

In many embodiments, a provider service 110 may be connected over a network 120 with the one or more cloud service providers 130, 140 to manage cloud accounts 132, 138, 142. For example, provider service 110 may interact with cloud service provider 130 to create additional cloud accounts or it may delete existing cloud accounts. In other embodiments, a resource manager 105 may be connected over the network 120 with the cloud service providers 130, 140 to create and delete cloud accounts 132, 138, 142 while provider service 110 may only connect with the cloud service providers 130, 140 to acquire account credentials for the cloud accounts created by the resource manager. In yet more embodiments, neither the resource manager 104 nor the provider service 110 create or delete cloud accounts 132, 138, 142, but instead are only aware of previously created accounts. For example, cloud accounts 132, 138, 142 may be created by a separate service not depicted in FIG. 1.

In various embodiments, the interaction between a provider service 110, or a resource manager 105 and the cloud service providers 130, 140 may take place using a published application programming interface (API). For example, cloud service providers 130, 140 may publish APIs to enable external services to communicate with the cloud service providers 130, 140 and manage the resources provided by the cloud service providers 130, 140. In many embodiments, the provider service 110 may incorporate the published APIs into software components using any number of programming languages such as Java, Python, Pearl, and C++. In some embodiments, the provider service 110 may define its own interface that incorporates multiple APIs from various cloud service providers 130, 140. For example, cloud service providers 130, 140 may publish APIs with a method for creating a new cloud account. However, the method signature for cloud service provider 130 may differ compared with the method signature for cloud service provider 140. In this case, a common interface may be defined within the provider service 110 with a single signature that will apply to any cloud service provider 130, 140. Then the interface may be implemented with logic for each of the different cloud service providers 130, 140 APIs.

FIG. 2 depicts an example logical structure within a cloud service provider 130. In some embodiments, a cloud service provider 130 has physical infrastructure in different locations across the world. This physical infrastructure may include multiple buildings housing numerous servers, computers, and networking infrastructure. In the logical world, these physical locations may be represented by regions. As shown in FIG. 2, this may be a region 210 and a region 220 where each region 210, 220 represents a collection of physical resources in different parts of the world. In some cases, each region 210, 220 may be further subdivided into availability zones (AZs). As shown in FIG. 2, region 210 may be divided into AZs 212, 214 and region 220 may be divided into AZs 222, 224.

In many embodiments, when a user or consumer creates a cloud account 230 on the cloud service provider 130, the account is not restricted to any particular region or availability zone, however the resources created in the cloud account 230 may be. For example, when creating a VPC in account 230, the user may need to choose a specific region for the VPC. As illustrated in FIG. 2, account 230 has created VPCs 232 and 234 in region 210 and VPCs 236 and 238 in region 220. In various embodiments, once a VPC has been created, multiple subnets may be added and the subnets may be created inside distinct AZs. As illustrated in FIG. 2, VPC 232 has created subnet 232a in AZ 212 and subnet 232b in AZ 214.

In various embodiments, many types of resources may be created within a VPC and on various predefined subnets. For example, as illustrated in FIG. 2, VPC 232 may have resources 240 and 241 created on subnet 232a and resources 242 and 243 on subnet 232b. In some cases, these resources may be virtual machines such as an Amazon EC2 server or block storage such as an Amazon EBS volume. In many embodiments, resources created within the same cloud account may be able to communicate with other resources within the same account regardless of whether they are in the same VPC. For example, resource 241 may communicate with resource 242 as well as resource 245. On the other hand, resource created within separate cloud accounts may not be able to communicate with each other, regardless of whether they are created in the same region or same AZs.

As discussed herein above in reference to FIG. 1, cloud service provider 130 may restrict each account to a certain number of resources. For example, account 230 may only be allowed to create four VPCs 232, 234, 236, 238 in the account. In many embodiments, as additional resources are needed an additional account 250 may be created for the additional resources. In other embodiments, cloud service provider 130 may have other restrictions between accounts. For example, resources created in account 230 may not be able to communicate as easily with resources created in account 250. In this case, if a new resource is necessary to support or expand the services provided by an existing resource, it may be necessary to create the new resource within the same account as the existing resource.

In many embodiments, an external resource manager tasked with creating and managing network resources may include some means or mechanism for organizing what resources have been created in which cloud accounts. In some implementations, a centralized method and means of managing the mappings between resources and cloud provider accounts is provided. In some embodiments, the method may be implemented by a processor executing a centralized service. In other embodiments, managing the mappings may be accomplished using a system with one or more processors and a memory accessible to the one or more processors comprising instructions that carry out the methods. In yet other embodiments, there may be a computer product with a plurality of instructions stored on a non-transitory computer readable medium. The methods and systems for managing and creating the mappings between resources and cloud accounts are discussed in more detail herein below.

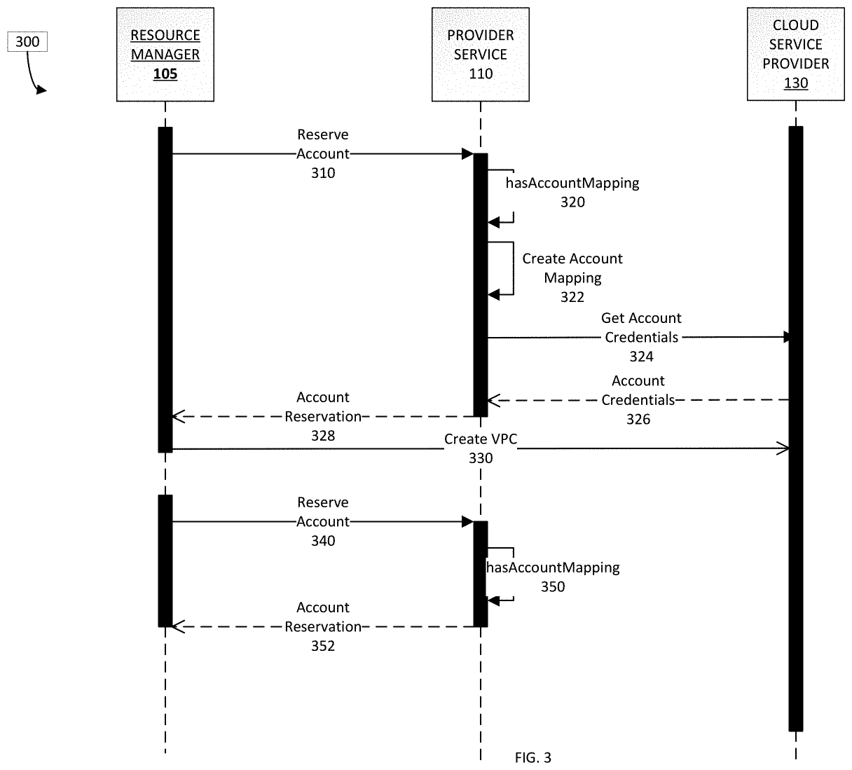

FIG. 3 depicts an example of steps performed to map cloud provider accounts with network resources. In many embodiments, a user may wish to create a new network resource using a resource manager 105. As discussed herein above, the network resource may be associated with a cloud account of a cloud service provider. The steps illustrated in FIG. 3 and further described herein below may provide for the necessary association between the desired network resource and a cloud account.

At step 310, after being instructed to create a new network resource by a user, the resource manager 105 may send a request to a provider service 110 to reserve a cloud account for the network resource. As described above, this request may be an RPC using a published API of the provider service 110. In some embodiments, the request to reserve a cloud account may include identifying features of the future network resource. For example, the RPC from the resource manager 105 to the provider service 110 may include a universally unique identifier (UUID) for the network resource. In other embodiments, the request may include a purpose of the account allocation. For example, the RPC from the resource manager 105 to the provider service 110 may include an enumerated type (enum) that corresponds with a purpose such as domain name service (DNS).

At step 320, after the provider service 110 has received the request from the resource manager 105 with an identifier for the network resource, the provider service 110 may proceed to determine whether a cloud account has already been reserved for the network resource.

At step 322, after the provider service 110 has determined that a cloud account has not already been reserved for the network resource, the provider service 110 may select an unassigned account from a collection of previously created accounts to be mapped to the network resource. In some embodiments, where the provider service 110 has a collection of multiple unassigned cloud accounts, the provider service 110 may use additional logic to determine an appropriate cloud account to be associated with the network resource. For example, the provider service 110 may be aware of how many resources are being used by each cloud account and may attempt to distribute network resources among the cloud accounts equitably. Alternatively, the provider service 110 may be aware of constraints in a particular cloud account that would make it incompatible with the network resource. In other embodiments, the request at step 310 may include additional information for the provider service 110 to use during account association. For example, the resource manager 105 may want the provider service 110 to allocate the network resource with a specific cloud account or for a specific purpose.

At step 324, after the provider service 110 has created a mapping between a cloud account and the network resource, the provider service 110 may then send a request to the cloud service provider 130 for dynamic, short lived account credentials associated with the unassigned account. The cloud provider service 110 may then receive the requested account credentials from the cloud service provider 130 at step 326.

At step 328, after the provider service 110 has created a mapping between a cloud account and the network resource, and received the temporary account credentials from the cloud service provider 130, the provider service 110 may then return the details of the mapping and the temporary account credentials to the resource manager 105.

At step 330, after the provider service 110 has returned the details of the mapping to the resource manager 105, the resource manager 105 may then proceed to interact with the cloud service provider 130 independent of the provider service 110 to create the necessary network resource within the associated cloud account of the cloud service provider 130. In some embodiments, the network resource created in the cloud account may be a VPC, a virtual machine, network accessible storage, a virtual network, etc.

In some embodiments, at the conclusion of steps 328 or 330, this may conclude the necessary interaction with the provider service 110. However, in other embodiments, after completion of steps 328 or 330, the resource manager 105 may encounter an issue precluding it from successfully creating the network resource. For example, the resource manager 105 may encounter an issue after receiving the account reservation from the provider service 110 at step 328 before it can create the network resource at step 330. In this case, the resource manager 105 may attempt to restart the process by sending an additional request at step 340 to the provider service 110 to reserve a cloud account for the same network resource. In some embodiments, this request may contain the same information contained in the original request from step 310.

At step 350, after the provider service 110 receives the duplicate request from the resource manager 105, the provider service 110 may treat the request like a new request. In some embodiments, after receiving the request, the provider service 110 may proceed to determine whether a cloud account has already been reserved for the network resource. In this example, because the provider service 110 has already allocated a cloud account to the network resource, there may be no need to send a request to the cloud service provider 130 or create a new account mapping. Instead, at step 352, the provider service 110 may return the existing mapping between the cloud account previously associated with the network resource to the resource manager.

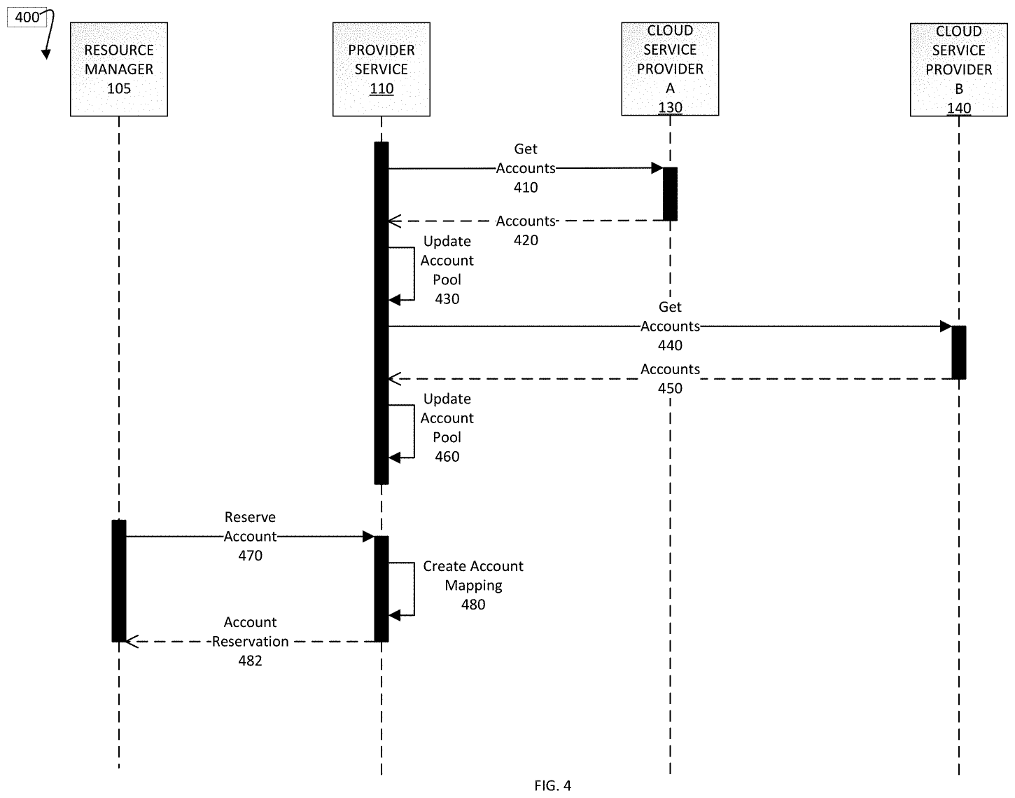

FIG. 4 depicts an additional example of steps performed to map cloud provider accounts from multiple cloud providers with network resources in accordance with another embodiments of the present invention. As described above, in some embodiments the provider service 110 may communicate with multiple cloud service providers so that a network resource may be allocated to a cloud account from any of the available cloud service providers. The steps illustrated in FIG. 4 and further described herein below may provide for the necessary association between the desired network resource and a cloud account from one of multiple cloud service providers.

At step 410, a provider service may become aware of a newly available cloud service provider A 130 and send a request to the cloud service provider A 130 to generate cloud accounts serviced by the cloud service provider A 130. In some embodiments, the provider service 110 may be notified by a separate service (not illustrated in FIG. 4) that there is a new cloud service provider or a new cloud account in the cloud service provider for use by network resources. For example, as existing cloud accounts reach their restrictions, as described herein above, additional cloud accounts may be created with a particular cloud service provider. In this case, the provider service 110 may independently become aware of the new cloud accounts.

At step 420, in response to the request sent by the provider service 110, the provider service 110 receives accounts and/or account credentials for the newly created cloud accounts provided by the cloud service provider A 130.

At step 430, after receiving the accounts and/or account credentials from cloud service provider A 130, the provider service 110 may store the accounts and/or account credentials in an account pool. In some embodiments, this account pool may only include account credentials for each account provided by the cloud service provider A 130. In other embodiments, the account pool may include additional information about each account such as, but not limited to, the number and type of resources already using that account.

As illustrated in FIG. 4, steps 410, 420, and 430 may be repeated as steps 440, 450, and 460 for a separate cloud service provider B 140. In some embodiments, these steps may be repeated as many times as are necessary until the provider service 110 has created enough cloud accounts for all available cloud service providers. In many embodiments, these steps may be executed by a persistent background process. In some embodiments, the account credentials received from the cloud service providers 130, 140 may be stored in the same data structure. In other embodiments, a separate data structure may be used to facilitate differences from one cloud service provider to the next. For example, while one cloud service provider A 130 may only use cloud accounts as a logical organization structure, another cloud service provider B 140 may define it logical structure using subscriptions and/or tenants in addition to accounts. In this case, one data structure may store the credentials for cloud service provider A 130, while another data structure may store the credentials for cloud service provider B 140.

At step 470, after the provider service 110 has generated all of the available account credentials from the one or more cloud service providers 130, 140, a resource manager 105 may send a request to the provider service 110 to reserve a cloud account for new network resource. As discussed herein above, in some embodiments, this request may only contain an identifier for the new network resource, while in other embodiments the request may contain additional information such as a purpose for the reservation. For example, the request may specify that the new network resource is to be created using services from cloud service provider B 140 instead of cloud service provider A 130. Alternatively, in many embodiments, the resource manager 105 may identify a specific cloud account for the new network resource, or the resource manager 105 may request that the provider service 110 allocate an account based on an existing network resource.

At step 480, after the provider service 110 has received the request from the resource manager 105, the provider service may identify an appropriate cloud account for the new network resource from the account pools. In some embodiments, the provider service 110 may identify a cloud account from the account pool based on the relative number of network resources allocated to a cloud account compared with other cloud accounts. In other embodiments, the provider service 110 may identify a cloud account based on constraints provided by the resource manager 105 as discussed further herein above. After identifying a cloud account for the new network resource, the provider service 110 may then create a mapping between the new network resource and the cloud account based on the account credentials for the cloud account.

At step 482, after the provider service 110 has identified a cloud account and/or created a mapping between a cloud account and the network resource, the provider service 110 may then return the details of the mapping to the resource manager 105. In some embodiments, these details may include only an identifier for the associated cloud account while in other embodiments, the details may include the account credentials associated with the cloud account acquired from the service provider of the cloud account.

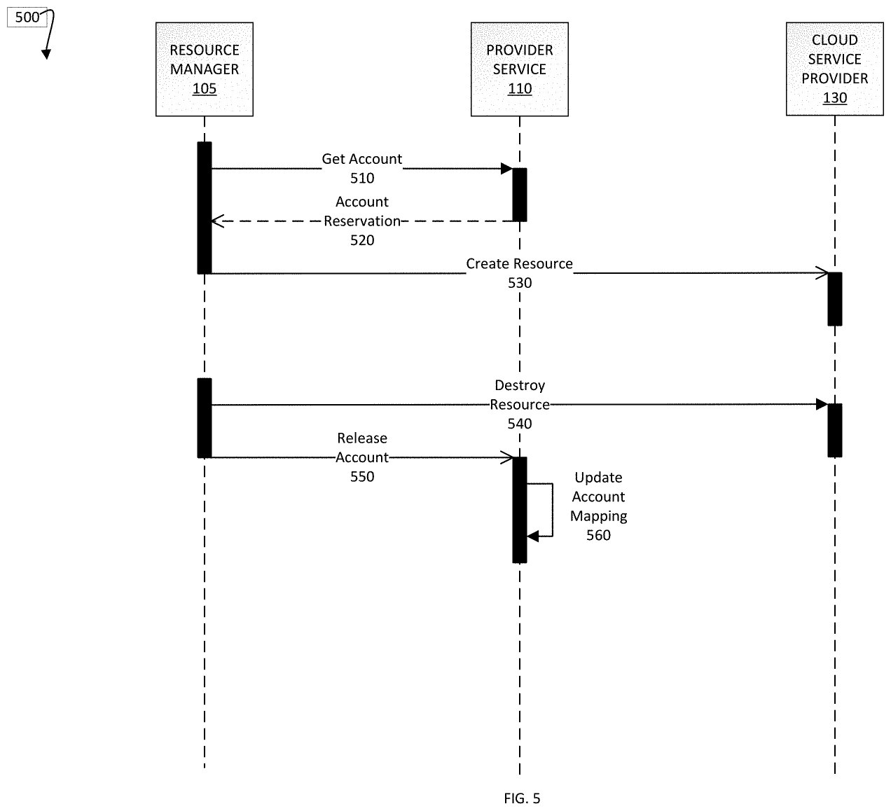

FIG. 5 depicts an example of steps performed to manage mappings of cloud provider accounts and network resources. As described herein above, in some embodiments, after the provider service 110 allocates a cloud account for a new network resource, the resource manager 105 may contact the cloud service provider 130 independently to create the new network resource within the cloud account provided by the provider service 110. In other embodiments, the resource manager 105 may need to create additional network resources to be used with an existing network resource. In some instances, due to networking and cloud service provider limitations, it may be necessary to create the additional network resource in the same cloud account as the existing network resource. For example, as described herein above, a VPC may have been created in a particular cloud account with a specific subnet that restricts communication with other resources available outside that cloud account. Due to these limitations, it may be necessary to create any additional resources in the same cloud account. In other embodiments, the resource manager 105 may determine that a network resource is no longer being used and can be destroyed. In this case, the provider service 110 may need to be notified so that it can maintain an accurate mapping of cloud accounts to network resources. The steps illustrated in FIG. 5 and further described herein below may provide for the necessary management of mappings between cloud accounts and network resources.

At step 510, after being instructed to create a new resource for an existing network resource, the resource manager 105 may send a request to the provider service 110 requesting the cloud account mapping for the existing network resource. In some embodiments, the request may include a reference to the existing network resource such as a UUID or any other identifier. After receiving the request from the resource manager 105, the provider service may then look up the associated cloud account for the existing network resource from a data store containing mappings between multiple network resources and multiple cloud accounts.

At step 520, after the provider service 110 identifies the associated cloud account for the existing network resource, the provider service 110 may then return the account mapping to the resource manager 105. In some embodiments, the provider service 110 may also return account credentials and/or other information pertaining to the cloud account.

At step 530, after receiving the cloud account information from the provider service 110, the resource manager 105 may then interact with the cloud service provider 130 in order to create and install the new resource in the cloud account provided by the provider service 110. In other embodiments, the resource manager may need to alter settings associated with the cloud account. For example, an existing network resource may need additional storage space, or the existing subnet may need to be updated. In this case, the resource manager 105 may use the account credentials provided by the provider service 110 to access the cloud account and update the necessary settings.

At step 540, the resource manager 105 may determine that a network resource is no longer necessary. For example, the application or website hosted on a VPC may no longer be necessary. In this case, the resource manager 105 may interact with cloud service provider 130 to destroy the VPC within the cloud account thereby freeing up the cloud account for future network resources.

At step 550, after the resource manager 105 has destroyed the network resource in the cloud account of the cloud service provider 130, the provider service 110 may need to be made aware of this change so that the cloud account is available for future resource allocations. In many embodiments, the resource manager 105 may send a notification to the provider service 110 notifying the provider service 110 that a resource has been destroyed. In some embodiments, this notification may include the identifier for the recently destroyed resource.

At step 560, after receiving the notification from the resource manager 105, the provider service 110 may identify a mapping between the recently destroyed resource and a cloud account of the cloud service provider 130. After identifying the mapping, the provider service 110, may then remove the mapping from the data store. In some embodiments, the provider service 110 may also update an account pool storing metrics related to how many resources are associated with each available cloud account.

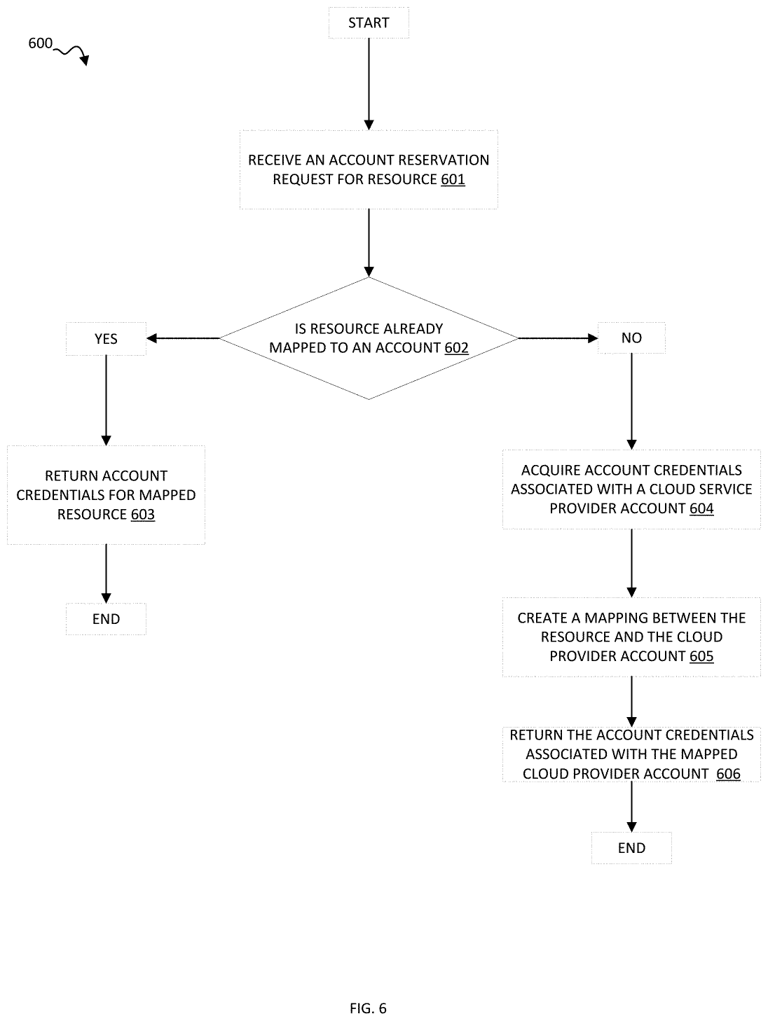

FIG. 6 depicts a flow diagram of an example method 600 for managing and creating cloud provider account mappings to resources. As discussed herein above, in some embodiments, a provider service may be implemented as a remote procedure call (RPC) service with a defined and published API. In many embodiments, the API may include an RPC to reserve an account. In some embodiments, the steps executed by the RPC service may include the steps illustrated in FIG. 6, and further described below.

As illustrated in FIG. 6, the method 600 may begin when the RPC service receives an account reservation request at step 601. As discussed herein above, the request may include an identifier for the resource such as a UUID or other similar identifier. In many embodiments, after receiving the request to reserve an account for the resource, the RPC service will determine whether a cloud account has already been reserved for the resource, as illustrated by step 602. If an account has already been reserved for the resource, the RPC service may return the existing mapping to the service that made the RPC call.

In other cases where an account has not been reserved for a resource, the RPC service may proceed to step 604. In many embodiments, the RPC service at step 604 will acquire account credentials for a cloud account of a cloud service provider. In other embodiments, the RPC service will acquire multiple account credentials corresponding with multiple cloud accounts of a cloud service provider. In some embodiments, as discussed herein above, the RPC service may already have an account pool containing all of the account credentials for every available cloud account of a cloud service provider.

At step 605, after acquiring account credentials for the cloud account, the RPC service may create a mapping between the cloud account and the resource. In many embodiments, after creating the mapping between the cloud account and the resource, the RPC service may store the mapping in a data store. At step 605, after the RPC service has created the mapping and after storing the mapping in a data store in accordance with some embodiments, the RPC service may then return the mapping to the service that requested the account reservation. In some embodiments, the RPC call may be defined in such a way that the object returned by the service is a mapping object, while in other embodiments, the method may return account credentials corresponding with the cloud account reserved for the resource.

As discussed herein above in reference to FIG. 5, a service API may define additional methods for invocation. In many embodiments, the API may also include a method to get an account reservation. For example, when a resource management service needs cloud account information for a resource that has already been allocated a cloud account, the resource management service may use a separate method invocation to retrieve the existing mapping. In other embodiments, the API may include a method to release an account reservation. For example, when a resource is no longer necessary or has already been destroyed in the cloud account, the resource management service may use an additional method invocation to destroy the corresponding mapping and thereby free up the cloud account for later resource allocations.

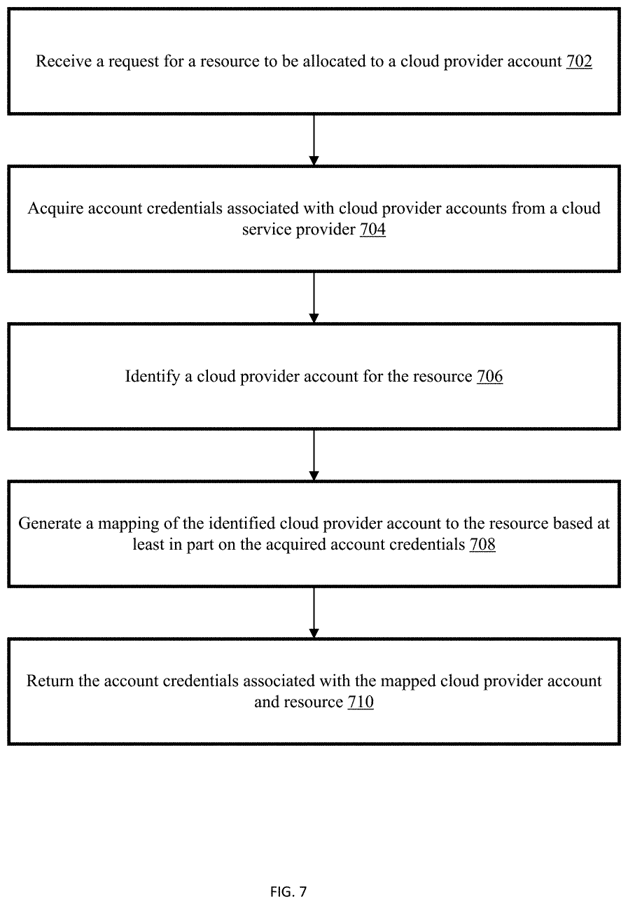

FIG. 7 depicts a flow diagram of an example method for mapping cloud provider accounts with network resources in accordance with various embodiments of the present invention. In many embodiments, the method may be implemented by a processor that executes a centralized service. In other embodiments, the method may encompass a plurality of instructions stored on a non-transitory computer readable medium. The steps illustrated in FIG. 7 and further described herein below may provide for an association between a new network resource and a cloud account.

At step 702, the method may begin by receiving a request for a resource to be allocated to a cloud provider account. As described above, this request may be an RPC using a published API of centralized process. In some embodiments, the request to reserve a cloud account may include identifying features of the resource. For example, the request may include a universally unique identifier (UUID) for the resource. In many embodiments, the method at this stage may determine whether the request has been received already. For example, if a resource with the same identifying features has already been included in a previous request. In this instance, if a resource has already been allocated a cloud provider account, the method may terminate and return information about the existing mapping.

At step 704, the method may proceed by acquiring account credentials associated with cloud provider accounts from a cloud service provider. In some embodiments, this may be repeated for any number of different cloud service providers. For example, the method may acquire a first set of account credentials from a cloud service provider such as Amazon Web Services, and a second set of account credentials from Microsoft Azure or Google Cloud Platform. In various embodiments, the acquired account credentials may be stored in a local or remote data store. For example, a pool of available accounts may be managed so that in future requests, there may be no need to acquire a set of account credentials from the cloud service providers unless there is an indication that a cloud account has been created or destroyed. In some embodiments, this account pool may only include account credentials for each account provided by the cloud service provider. In other embodiments, the account pool may include additional information about each account such as, but not limited to, the number and type of resources already using that account.

At step 706, the method may proceed to identify an appropriate cloud account to be associated with the resource. In some embodiments, identifying an appropriate cloud account may include determining how many resources are being used by each cloud account and attempting to distribute resources among the cloud accounts equitably. In other embodiments, identifying an appropriate cloud account may include determining constraints associated with a particular cloud account or cloud service provider that might make it incompatible with the resource. In various embodiments, the request may include constraints to be used during cloud account identification. For example, the request may specify a particular cloud account.

At step 708, the method may then generate a mapping between the resource and the identified cloud account based on the account credentials for the cloud account. In many embodiments, after generating the mapping between the cloud account and the resource, the method may also include steps to store the mapping in a data store. For example, a data structure may be created mapping resource identifiers to cloud provider account identifiers. In some embodiments, the stored mappings may be used for additional methods. For example, and as discussed herein above, an additional method may be defined to retrieve existing mappings between cloud provider accounts and resources. In this case, a method may receive an identifier corresponding to a resource, and may look up the associated cloud provider account in the data store using the resource identifier.

At step 710, the method may finish by returning the generated mapping of the identified cloud account and the resource to the source of the initial request. In some embodiments, these details may include only an identifier for the associated cloud account while in other embodiments, the details may include the account credentials associated with the cloud account acquired from the service provider.

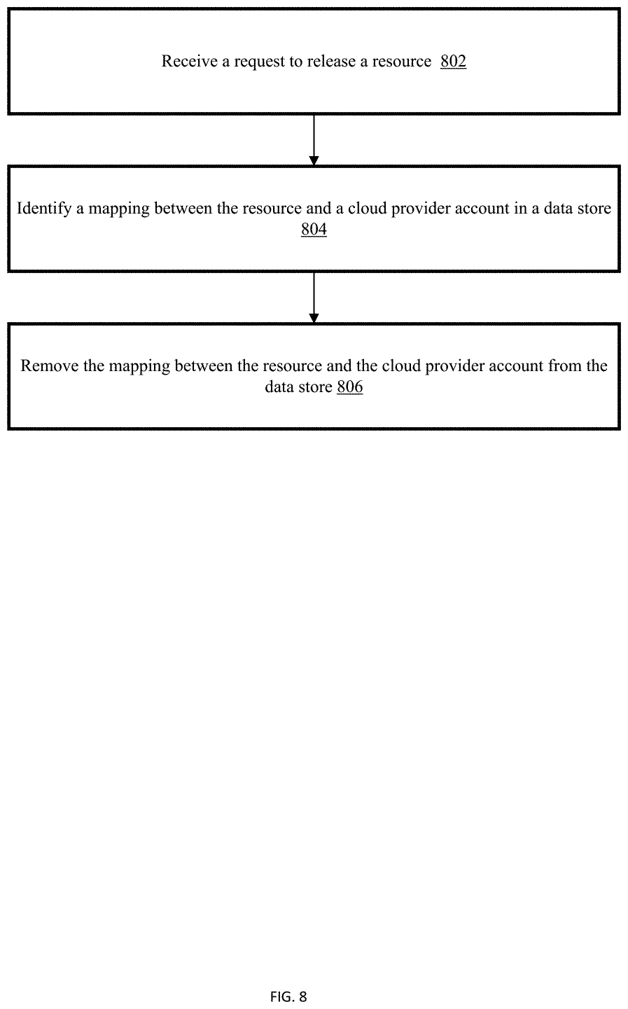

FIG. 8 depicts a flow diagram of an example method for erasing mappings of cloud provider accounts with network resources. In various embodiments, when a resource is no longer in use, the resource may be destroyed on the cloud provider account. In this case, a mapping between the resource and the cloud provider account may need to be removed to maintain an accurate list of mappings between resources and cloud provider accounts. In many embodiments, a method for erasing the mapping may be provided. In some embodiments, the method may be implemented by a processor that executes a centralized service. In other embodiments, the method may encompass a plurality of instructions stored on a non-transitory computer readable medium. The steps illustrated in FIG. 8 and further described herein below may provide for the necessary management and deletion of mappings between cloud accounts and network resources.

At step 802, the method may begin by receiving a request to release a resource from any existing mapping. As described above, this request may be an RPC using a published API of a centralized process. In some embodiments, the request to release the resource may include identifying features of the resource. For example, the request may include a universally unique identifier (UUID) for the resource.

At step 804, the method may proceed to identify a mapping between the resource and a cloud provider account. As discussed herein above, in many embodiments there may be a data store containing multiple mappings of resources to cloud provider accounts. In this case, identifying the mapping between the resource and a cloud provider account may include searching through a data store using an identifier of the resource.

At step 806, the method may proceed to remove the mapping between the resource and the identified cloud provider account from the data store. In many embodiments, this may include erasing an entry in a data store. In other embodiments, the method may include additional steps to maintain data consistency. For example, there may be a data store containing metrics for each of the available cloud provider accounts such as how many resources are using a cloud account, or what types of resources have been created in the cloud account. In this case, after erasing the mapping in the data store, additional steps may be necessary to update the stored metrics of the cloud account for which the resource was previously allocated.

Numerous specific details are set forth herein to provide a thorough understanding of the claimed subject matter. However, those skilled in the art will understand that the claimed subject matter may be practiced without these specific details. For example, reference to remote procedure calls (RPCs) should not be considered as limiting the invention solely to that use, as other appropriate techniques known in the art for communicating with local or remote service may be employed in the practice of the present invention such as a REST architecture or SOAP protocol. Similarly, references to the use of SQL databases as an appropriate data storage structure should be understood as an example where alternative data storage techniques will enable a user to practice the invention as well. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method of creating and managing mappings between cloud based resources and cloud provider accounts, the method comprising:
acquiring, by a processor that executes a centralized service, account credentials from a cloud provider, the account credentials being associated with a cloud provider account of the cloud provider;
receiving, by the processor, a request to allocate account credentials to a network resource;
generating, by the processor, a mapping of the cloud provider account with the network resource based at least in part on the acquired account credentials of the cloud provider account; and
returning, by the processor, the mapping based on the cloud provider account.

2. The method in accordance with claim 1, further comprising storing, by the processor, the mapping of the cloud provider account with the network resource in a data store.

3. The method in accordance with claim 2, further comprising:
identifying, by the processor, an existing mapping of the network resource with the cloud provider account in the data store; and
returning, by the processor, the existing mapping.

4. The method in accordance with claim 1, further comprising erasing, by the processor, the mapping upon destruction of the corresponding network resource.

5. The method in accordance with claim 1, further comprising:
acquiring, by the processor, account credentials from the cloud provider, the account credentials being associated with a second cloud provider account of the cloud provider;
receiving, by the processor, a request to allocate the account credentials of the second cloud provider account to a second network resource;
generating, by the processor, a mapping of the second cloud provider account with the second network resource based at least in part on the acquired account credentials of the second cloud provider account; and
returning, by the processor, the mapping based on the second cloud provider account.

6. The method in accordance with claim 1, wherein the centralized service comprises a remote procedure call (RPC) service.

7. The method in accordance with claim 1, wherein the network resource includes a virtual network.

8. The method in accordance with claim 1, wherein the network resource includes a virtual private cloud (VPC).

9. A system comprising:
one or more processors; and
a memory accessible to the one or more processors, the memory comprising instructions that, when executed by the one or more processors, cause the one or more processors to:
acquire, by a centralized service, one or more account credentials from a cloud provider, the one or more account credentials being associated with one or more cloud provider accounts of the cloud provider;
receive, by the centralized service, a request to allocate one of the one or more cloud provider accounts to a network resource;
identify, by the centralized service, a cloud provider account from the one or more cloud provider accounts to be associated with the network resource;
generate, by the centralized service, a mapping of the cloud provider account with the network resource based at least in part on the acquired account credentials of the cloud provider account; and
return, by the centralized service, a response having the account credentials of the cloud provider account.

10. The system of claim 9, wherein the one or more processors are further configured to:
store, by the centralized service, the mapping of the cloud provider account with the network resource in a data store.

11. The system of claim 10, wherein the one or more processors are further configured to:
receive, by the centralized service, a second request to allocate one of the one or more cloud provider accounts to the network resource;
identify, by the centralized service, the existing mapping of the cloud provider account with the network resource in the data store; and
return, by the centralized service, the existing mapping.

12. The system of claim 9, wherein the request to allocate one of the one or more cloud provider accounts to the network resource further comprises an account identifier for a specific account to be allocated to the network resource.

13. The system of claim 9, wherein the one or more processors are further configured to:
receive, by the centralized service, a request to release the cloud provider account from the network resource; and
erase, by the centralized service, the mapping of the cloud provider account with the network resource.

14. The system of claim 9, wherein the centralized service comprises a remote procedure call (RPC) service.

15. The system of claim 9, wherein the network resource includes a virtual network.

16. The system of claim 9, wherein the one or more processors are further configured to:
store, by the centralized service, the one or more account credentials from the cloud provider in a data store.

17. A computer product comprising a non-transitory computer readable medium storing a plurality of instructions, the plurality of instructions comprising:
receiving, by a provider service, a request to allocate a cloud provider account to a network resource;
acquiring, by the provider service, a first set of account credentials from a first cloud provider and a second set of account credentials from a second cloud provider, wherein the first set of account credentials are associated with cloud provider accounts of the first cloud provider and the second set of account credentials are associated with cloud provider accounts of the second cloud provider;
identifying, by the provider service, a cloud provider account from the first and second sets of account credentials to be associated with the network resource;
generating, by the provider service, a mapping of the identified cloud provider account with the network resource based at least in part on the acquired account credentials of the cloud provider account; and
returning, by the provider service, a response having the account credentials of the identified cloud provider account.

18. The computer product of claim 17, wherein the plurality of instructions further comprise:
receiving, by the provider service, a request to retrieve account credentials for a network resource;
identifying, by the provider service, a mapping from the network resource to a cloud provider account; and
returning, by the provider service, a response having the account credentials for the cloud provider account.

19. The computer product of claim 17, wherein the plurality of instructions further comprise:
receiving, by the provider service, a request to release the allocated cloud provider account from the network resource; and
erasing, by the provider service, the mapping of the cloud provider account with the network resource.

20. The computer product of claim 17, wherein the request to allocate a cloud provider account to the network resource further comprises a request to allocate the network resource to a specific cloud provider.
